(19) United States
(12) Patent Application Publication
(10) Pub. No.: US 2023/0106749 A1
(43) Pub. Date: Apr. 6, 2023

(54) THREE-DIMENSIONAL MEASUREMENT DEVICE

(71) Applicant: FARO Technologies, Inc., Lake Mary, FL (US)

(72) Inventor: Gerrit Hillebrand, Stuttgart (DE)

(21) Appl. No.: 17/859,218

(22) Filed: Jul. 7, 2022

Related U.S. Application Data
(60) Provisional application No. 63/251,116, filed on Oct. 1, 2021.

(51) Int. Cl. G01S 7/481; G01S 17/894; G06T 17/05

(52) U.S. Cl. CPC G01S 7/4817; G01S 17/894; G06T 17/05; G06T 2207/10028

(57) ABSTRACT

A method includes capturing a frame including a 3D point cloud and a 2D image. A key point is detected in the 2D image, the key point is a candidate to be used as a feature. A 3D patch of a predetermined dimension is created that includes points surrounding a 3D position of the key point. The 3D position and the points of the 3D patch are determined from the 3D point cloud. Based on a determination that the points in the 3D patch are on a single plane based on the corresponding 3D coordinates, a descriptor for the 3D patch is computed. The frame is registered with a second frame by matching the descriptor for the 3D patch with a second descriptor associated with a second 3D patch from the second frame. The 3D point cloud is aligned with multiple 3D point clouds based on the registered frame.

### CROSS REFERENCE TO RELATED APPLICATIONS

This application claims the benefit of U.S. Provisional Application Ser. No. 63/251,116, filed Oct. 1, 2021, the entire disclosure of which is incorporated herein by reference.

### BACKGROUND

The subject matter disclosed herein relates to a handheld three-dimensional (3D) measurement device, and particularly to using orthonormalized pre-aligned 3D patches and descriptors when generating scans using the 3D measurement device.

A 3D triangulation scanner, also referred to as a 3D imager, is a portable 3D measurement device having a projector that projects light patterns on the surface of an object to be scanned. One (or more) cameras, having a predetermined positions and alignment relative to the projector, records images of the light pattern on the surface of an object. The three-dimensional coordinates of elements in the light pattern can be determined by trigonometric methods, such as by using triangulation. Other types of 3D measuring devices may also be used to measure 3D coordinates, such as those that use time of flight techniques (e.g., laser trackers, laser scanners or time of flight cameras) for measuring the amount of time it takes for light to travel to the surface and return to the device.

While existing handheld 3D triangulation scanners are suitable for their intended purpose, the need for improvement remains, such as in providing ability to obtain increased density of measured 3D points, and ability to obtain faster and simpler post-processing of scan data.

### BRIEF DESCRIPTION

According to one aspect of the disclosure, an apparatus includes a scanner that captures a 3D map of an environment, the 3D map comprising a plurality of 3D point clouds. The apparatus also includes a camera that captures a 2D image corresponding to each 3D point cloud from the plurality of 3D point clouds. The apparatus further includes one or more processors coupled with the scanner and the camera, the one or more processors configured to perform a method. The method includes capturing a frame comprising a 3D point cloud and the 2D image. The method further includes detecting a key point in the 2D image, the key point can be used as a feature. The method further includes creating a 3D patch, wherein the 3D patch comprises points surrounding a 3D position of the key point, the 3D position and the points of the 3D patch are determined from the 3D point cloud. The method further includes based on a determination that the points in the 3D patch are on a single plane based on the corresponding 3D coordinates, computing a descriptor for the 3D patch. The method further includes registering the frame with a second frame by matching the descriptor for the 3D patch with a second descriptor associated with a second 3D patch from the second frame. The method further includes aligning the 3D point cloud with the plurality of 3D point clouds based on the registered frame.

According to one or more aspects, a method includes capturing a frame that includes a 3D point cloud and a 2D image to generate a map of an environment, the map generated using a plurality of 3D point clouds. The method further includes detecting a key point in the 2D image, the key point is a candidate to be used as a feature. The method further includes creating a 3D patch of a predetermined dimension, wherein the 3D patch comprises points surrounding a 3D position of the key point, the 3D position and the points of the 3D patch are determined from the 3D point cloud. The method further includes based on a determination that the points in the 3D patch are on a single plane based on the corresponding 3D coordinates, computing a descriptor for the 3D patch. The method further includes registering the frame with a second frame by matching the descriptor for the 3D patch with a second descriptor associated with a second 3D patch from the second frame. The method further includes aligning the 3D point cloud with the plurality of 3D point clouds based on the registered frame. The method is a computer-implemented method in one or more aspects.

According to one or more aspects, a system includes a scanner that has a 3D scanner, and a camera. The system also includes a computing system coupled with the scanner. The computing system performs a method.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a front perspective view of a 3D triangulation scanner according to an embodiment of the disclosure;

FIG. 2 is a rear perspective view of the 3D triangulation scanner according to an embodiment of the disclosure;

FIG. 3A and FIG. 3B are block diagrams of electronics coupled to the triangulation scanner according to an embodiment of the disclosure;

FIG. 4 illustrates interconnection of a mobile PC with a mobile display using USB tethering according to an embodiment of the disclosure;

FIG. 5 is a schematic representation of a triangulation scanner having a projector and a camera according to an embodiment of the disclosure;

FIG. 6A is a schematic representation of a triangulation scanner having a projector and two cameras according to an embodiment of the disclosure;

FIG. 6B is a perspective view of a triangulation scanner having a projector, two triangulation cameras, and a registration camera according to an embodiment of the disclosure;

FIG. 7 is a schematic representation illustrating epipolar terminology;

FIG. 8 is a schematic representation illustrating how epipolar relations may be advantageously used in when two cameras and a projector are placed in a triangular shape according to an embodiment of the disclosure;

FIG. 9 illustrates a system in which 3D coordinates are determined for a grid of uncoded spots projected onto an object according to an embodiment of the disclosure;

FIG. 10 is a schematic illustration of a scanner accordance with an embodiment;

FIG. 11 depicts a high level operational flow for implementing SLAM according to one or more examples;

FIG. 12 depicts a flowchart of a method for using orthonormalized pre-aligned 3D patches for performing SLAM according to one or more embodiments;

FIG. 13 depicts a block diagram for detection of key points according to one or more embodiments;

FIG. 14 depicts an example of a 3D patch according to one or more embodiments;

FIG. 15 depicts an example of recolored 3D patch according to one or more embodiments;

FIG. 16 depicts an example of a super-resolution 3D patch according to one or more embodiments;

FIG. 17 depicts a flowchart for using orthonormal 3D patches for performing loop closure according to one or more embodiments;

FIG. 18 depicts an example scenario of applying loop closure according to one or more embodiments; and

FIG. 19 depicts an example of measurement error according to one or more embodiments.

The detailed description explains embodiments of the disclosure, together with advantages and features, by way of example with reference to the drawings.

### DETAILED DESCRIPTION

Technical solutions are described herein to facilitate a 3D measurement device, such as a 3D triangulation scanner, or 3D imager to capture scans of a scene efficiently and accurately. An example of a 3D triangulation scanner is one of the FARO® Freestyle series scanners. When analyzing the scene of a crime or crash or documenting a construction site or an object being inspected, it is desirable to capture the details of the scene quickly, efficiently, and accurately. Various actors involved in capturing the details, such as contractors, engineers, surveyors, architects, investigators, analysts, reconstructionist(s), prosecutors, etc., use handheld 3D imagers, such as the FARO® Freestyle 2 Handheld Scanner for fast, photorealistic 3D reality capture. It should be noted that the technical solutions described herein are described using examples of a 3D handheld triangulation scanner, however, the technical solutions can be applicable for other types of 3D measurement devices, such as stationary 3D laser scanners.

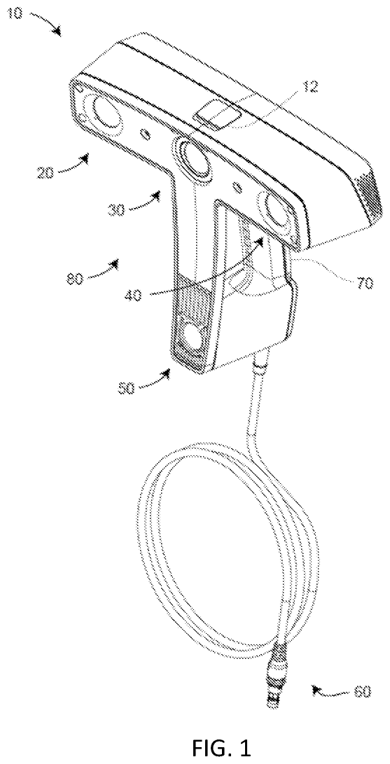

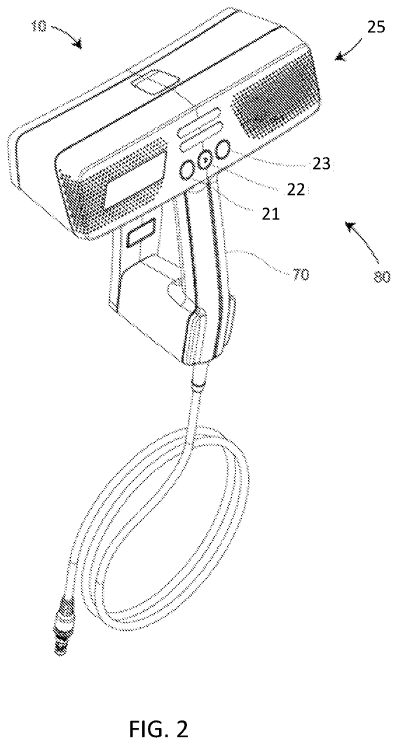

FIG. 1 is a front isometric view of a handheld 3D triangulation scanner 10 (“scanner”), also referred to as a handheld 3D imager. In an embodiment, the scanner 10 includes a first infrared (IR) camera 20, a second IR camera 40, a registration camera 30, a projector 50, an Ethernet cable 60 and a handle 70. In an embodiment, the registration camera 30 is a color camera. Ethernet is a family of computer networking technologies standardized under IEEE 802.3. The enclosure 80 includes the outmost enclosing elements of the scanner 10, as explained in more detail herein below. FIG. 2 is a rear perspective view of the scanner 10 further showing an exemplary perforated rear cover 25 and a scan start/stop button 22. In an embodiment, buttons 21, 23 may be programmed to perform functions according to the instructions of a computer program, the computer program either stored internally within the scanner 10 or externally in an external computer. In an embodiment, each of the buttons 22, 21, 23 includes at its periphery a ring illuminated by a light emitting diode (LED).

In an embodiment, the scanner 10 of FIG. 1 is the scanner described in commonly owned U.S. patent application Ser. No. 16/806,548, the contents of which are incorporated by reference herein in its entirety.

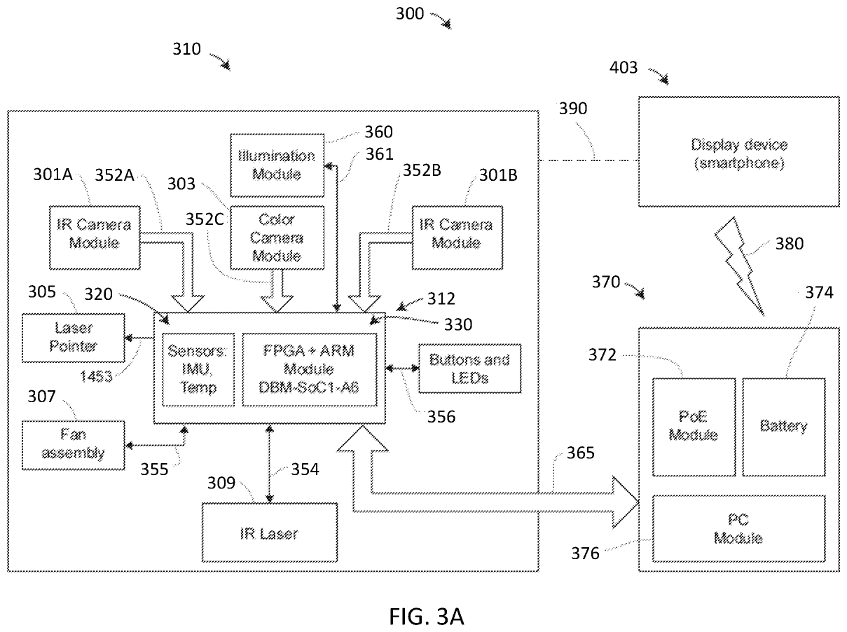

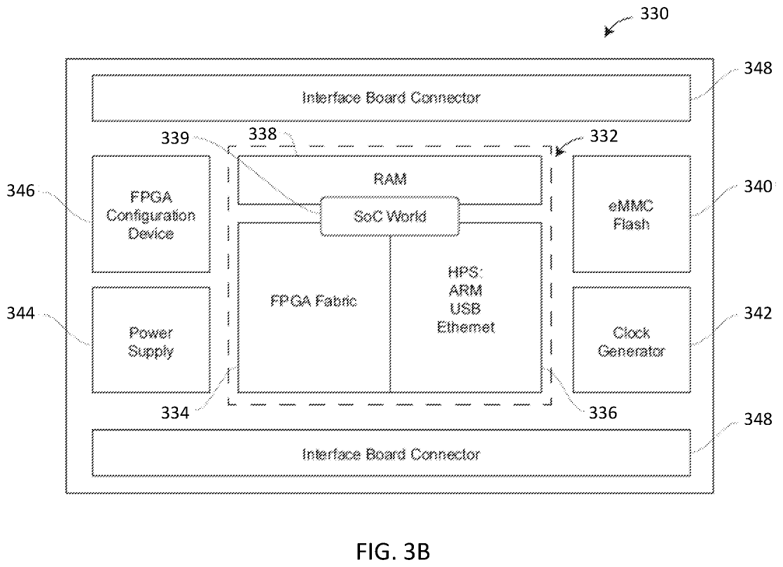

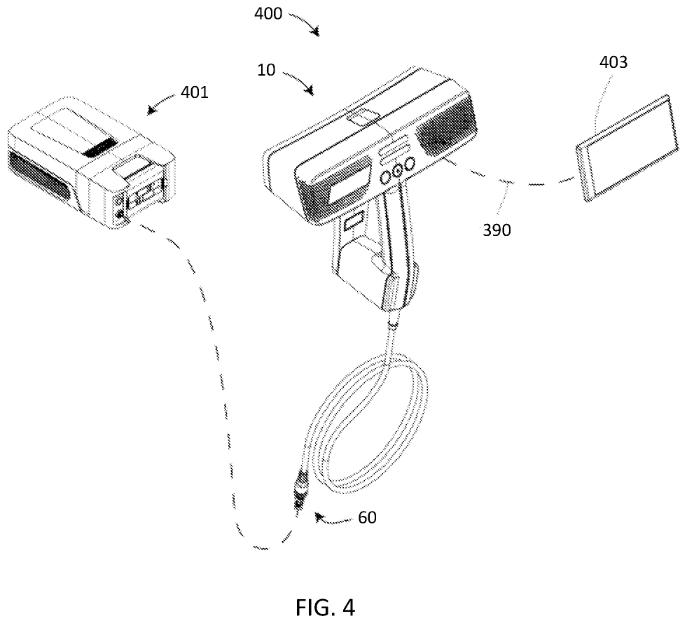

FIG. 3A is a block diagram of system electronics 300 that in an embodiment is included in the scanner system 10. In an embodiment, the electronics 300 includes electronics 310 within the handheld scanner 10, electronics 370 within the mobile PC 401 (FIG. 4), electronics within the mobile computing device 403, electronics within other electronic devices such as accessories that attach to an accessory interface (not shown), and electronics such as external computers that cooperate with the scanner system electronics 300. In an embodiment, the electronics 310 includes a circuit baseboard 312 that includes a sensor collection 320 and a computing module 330, which is further shown in FIG. 3B. In an embodiment, the sensor collection 320 includes an IMU and one or more temperature sensors. In an embodiment, the computing module 330 includes a system-on-a-chip (SoC) field programmable gate array (FPGA) 332. In an embodiment, the SoC FPGA 332 is a Cyclone V SoC FPGA that includes dual 800 MHz Cortex A9 cores, which are Advanced RISC Machine (ARM) devices. The Cyclone V SoC FPGA is manufactured by Intel Corporation, with headquarters in Santa Clara, Calif. FIG. 3B represents the SoC FPGA 332 in block diagram form as including FPGA fabric 334, a Hard Processor System (HPS) 336, and random access memory (RAM) 338 tied together in the SoC 339. In an embodiment, the HPS 336 provides peripheral functions such as Gigabit Ethernet and USB. In an embodiment, the computing module 330 further includes an embedded MultiMedia Card (eMMC) 340 having flash memory, a clock generator 342, a power supply 344, an FPGA configuration device 346, and interface board connectors 348 for electrical communication with the rest of the system. It is understood that the components mentioned above are just examples, and that in other embodiments, different components can be used.

Signals from the infrared (IR) cameras 301A, 301B and the registration camera 303 are fed from camera boards through cables to the circuit baseboard 312. Image signals 352A, 352B, 352C from the cables are processed by the computing module 330. In an embodiment, the computing module 330 provides a signal 353 that initiates emission of light from the laser pointer 305. A TE control circuit communicates with the TE cooler within the infrared laser 309 through a bidirectional signal line 354. In an embodiment, the TE control circuit is included within the SoC FPGA 332. In another embodiment, the TE control circuit is a separate circuit on the baseboard 312. A control line 355 sends a signal to the fan assembly 307 to set the speed of the fans. In an embodiment, the controlled speed is based at least in part on the temperature as measured by temperature sensors within the sensor unit 320. In an embodiment, the baseboard 312 receives and sends signals to buttons 22, 21, 23 and their LEDs through the signal line 356. In an embodiment, the baseboard 312 sends over a line 361 a signal to an illumination module 360 that causes white light from the LEDs to be turned on or off.

In an embodiment, bidirectional communication between the electronics 310 and the electronics 370 is enabled by Ethernet communications link 365. In an embodiment, the Ethernet link is provided by the cable 60. In an embodiment, the cable 60 attaches to the mobile PC 401 through the connector on the bottom of the handle. The Ethernet communications link 365 is further operable to provide or transfer power to the electronics 310 through the user of a custom Power over Ethernet (PoE) module 372 coupled to the battery 374. In an embodiment, the mobile PC 370 further includes a PC module 376, which in an embodiment is an Intel® Next Unit of Computing (NUC) processor. The NUC is manufactured by Intel Corporation, with headquarters in Santa Clara, Calif. In an embodiment, the mobile PC 370 is configured to be portable, such as by attaching to a belt and carried around the waist or shoulder of an operator. It is understood that other types of PC module 376 can be used in other embodiments, and that NUC is just an example.

In an embodiment, shown in FIG. 4, the scanner 10 may be arranged in a first configuration 400. In this embodiment, a display 403, such as a mobile computing device or cellular phone may be configured to communicate with the scanner 10 or the mobile computing device or mobile PC 401. The communication between the display device 403 and the mobile PC 401 may be by cable or via a wireless medium (e.g. Bluetooth™ or Wi-Fi). In an embodiment, a USB cable connects the mobile phone to the scanner 10, for example, through a USB cable 490 to a compatible USB port on the bottom of the main body of the scanner 10. In an embodiment, using USB tethering, the mobile display 403 is connected to the mobile PC 401 by the Ethernet cable 60 that provides Ethernet link 365.

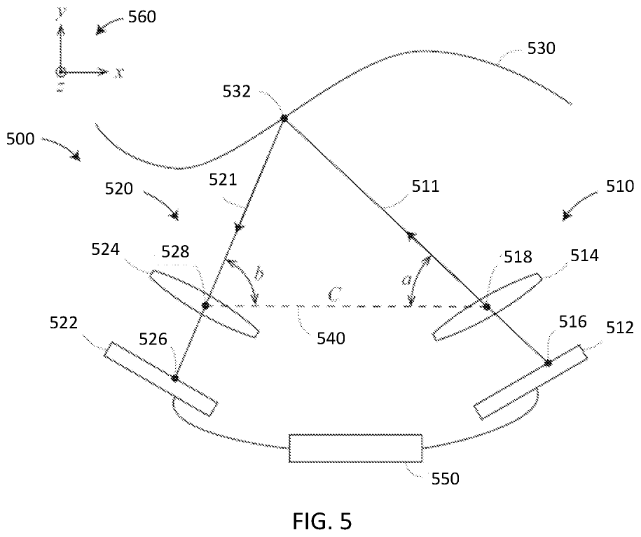

FIG. 5 shows a triangulation scanner (3D imager) 500 that projects a pattern of light over an area on a surface 530. The scanner 500, which has a frame of reference 560, includes a projector 510 and a camera 520. In an embodiment, the projector 510 includes an illuminated projector pattern generator 512, a projector lens 514, and a perspective center 518 through which a ray of light 511 emerges. The ray of light 511 emerges from a corrected point 516 having a corrected position on the pattern generator 512. In an embodiment, the point 516 has been corrected to account for aberrations of the projector, including aberrations of the lens 514, in order to cause the ray to pass through the perspective center 518, thereby simplifying triangulation calculations. In an embodiment, the pattern generator 512 includes a light source that sends a beam of light through a diffractive optical element (DOE). For example, the light source might be the infrared laser 309. A beam of light from the infrared laser 309 passes through the DOE, which diffracts the light into a diverging pattern such as a diverging grid of spots. In an embodiment, one of the projected rays of light 511 has an angle corresponding to the angle a in FIG. 5. In another embodiment, the pattern generator 512 includes a light source and a digital micromirror device (DMD). In other embodiments, other types of pattern generators 512 are used.

The ray of light 511 intersects the surface 530 in a point 532, which is reflected (scattered) off the surface and sent through the camera lens 524 to create a clear image of the pattern on the surface 530 of a photosensitive array 522. The light from the point 532 passes in a ray 521 through the camera perspective center 528 to form an image spot at the corrected point 526. The position of the image spot is mathematically adjusted to correct for aberrations of the camera lens. Corresponding relationship is determined between the point 526 on the photosensitive array 522 and the point 516 on the illuminated projector pattern generator 512. As explained herein below, the correspondence may be obtained by using a coded or an uncoded pattern of projected light. Once the correspondence is known, the angles a and b in FIG. 5 may be determined. The baseline 540, which is a line segment drawn between the perspective centers 518 and 528, has a length C. Knowing the angles, a, b, and the length C, all the angles and side lengths of the triangle 528-532-518 may be determined. Digital image information is transmitted to a processor 550, which determines 3D coordinates of the surface 530. The processor 550 may also instruct the illuminated pattern generator 512 to generate an appropriate pattern.

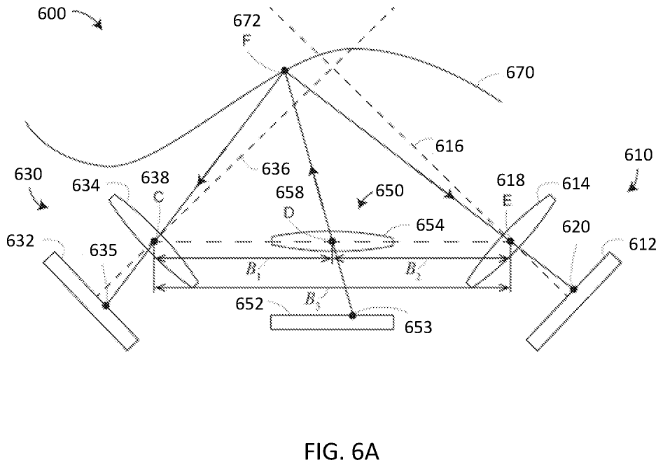

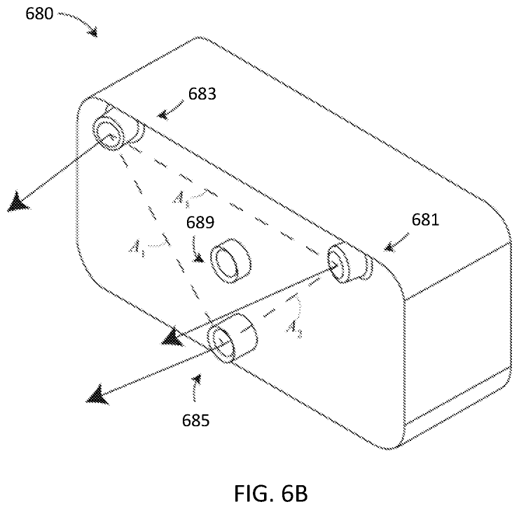

FIG. 6A shows a structured light triangulation scanner 600 having a projector 650, a first camera 610, and a second camera 630. The projector 650 creates a pattern of light on a pattern generator 652, which it projects from a corrected point 653 of the pattern through a perspective center 658 (point D) of the lens 654 onto an object surface 670 at a point 672 (point F). In an embodiment, the pattern generator is a DOE that projects a pattern based on principles of diffractive optics. In other embodiments, other types of pattern generators are used. The point 672 is imaged by the first camera 610 by receiving a ray of light from the point 672 through a perspective center 618 (point E) of a lens 614 onto the surface of a photosensitive array 612 of the camera as a corrected point 620. The point 620 is corrected in the read-out data by applying a correction factor to remove the effects of lens aberrations. The point 672 is likewise imaged by the second camera 630 by receiving a ray of light from the point 672 through a perspective center 638 (point C) of the lens 634 onto the surface of a photosensitive array 632 of the second camera as a corrected point 635. It should be understood that any reference to a lens in this document is understood to mean any possible combination of lens elements and apertures.

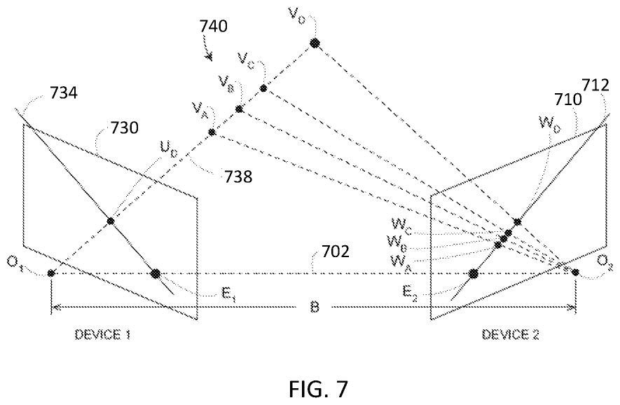

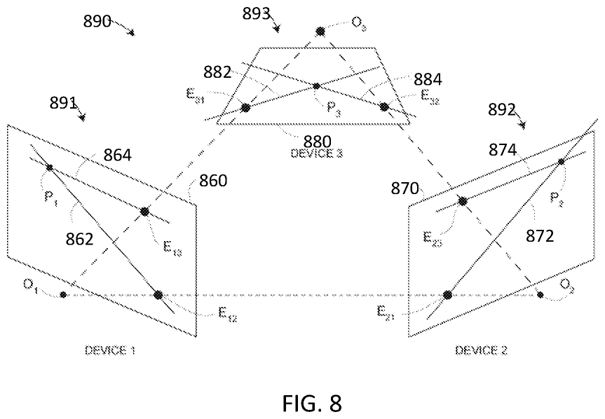

FIG. 6B shows 3D imager 680 having two cameras, 683 and a projector 685 arranged in a triangle A₁-A₂-A₃. In an embodiment, the 3D imager 680 of FIG. 6B further includes a camera 689 that may be used to provide color (texture) information for incorporation into the 3D image. In addition, the camera 689 may be used to register multiple 3D images through the use of videogrammetry. This triangular arrangement provides additional information beyond that available for two cameras and a projector arranged in a straight line as illustrated in FIG. 6A. The additional information may be understood in reference to FIG. 7, which explains the concept of epipolar constraints, and FIG. 8, which explains how epipolar constraints are advantageously applied to the triangular arrangement of the 3D imager 680. In an embodiment, the elements 681, 683, 685, 689 in FIG. 6B correspond to the elements 40, 20, 50, 30 in FIG. 1.

In FIG. 7, a 3D triangulation instrument 740 includes a device 1 and a device 2 on the left and right sides, respectively. Device 1 and device 2 may be two cameras or device 1 and device 2 may be one camera and one projector. Each of the two devices, whether a camera or a projector, has a perspective center, O₁ and O₂, and a reference plane, 730 or 710. The perspective centers are separated by a baseline distance B, which is the length of the line 702 between O₁ and O₂. The perspective centers O₁, O₂ are points through which rays of light may be considered to travel, either to or from a point on an object. These rays of light either emerge from an illuminated projector pattern or impinge on a photosensitive array.

In FIG. 7, a device 1 has a perspective center O₁ and a reference plane 2130, where the reference plane 730 is, for the purpose of analysis, equivalent to an image plane of the object point O₁ 730. In other words, the reference plane 730 is a projection of the image plane about the perspective center O₁. A device 2 has a perspective center O₂ and a reference plane 710. A line 702 drawn between the perspective centers O₁ and O₂ crosses the planes 730 and 710 at the epipole points E₁, E₂, respectively. Consider a point U_{D} on the plane 730. If device 1 is a camera, an object point that produces the point U_{D} on the reference plane 730 (which is equivalent to a corresponding point on the image) must lie on the line 738. The object point might be, for example, one of the points V_{A}, V_{B}, V_{C}, or V_{D}. These four object points correspond to the points W_{A}, W_{B}, W_{C}, W_{D}, respectively, on the reference plane 710 of device 2. This is true whether device 2 is a camera or a projector. It is also true that the four points lie on a straight line 712 in the plane 710. This line, which is the line of intersection of the reference plane 710 with the plane of O₁-O₂-U_{D}, is referred to as the epipolar line 712. It follows that any epipolar line on the reference plane 710 passes through the epipole E₂. Just as there is an epipolar line on the reference plane 710 of device 2 for any point U_{D} on the reference plane of device 1, there is also an epipolar line 734 on the reference plane 730 of device 1 for any point on the reference plane 710 of device 2.

FIG. 8 illustrates the epipolar relationships for a 3D imager 890 corresponding to 3D imager 880 in which two cameras and one projector are arranged in a triangular pattern. In general, the device 1, device 2, and device 3 may be any combination of cameras and projectors as long as at least one of the devices is a camera. Each of the three devices 891, 892, 893 has a perspective center O₁, O₂, O₃, respectively, and a reference plane 860, 870, and 880, respectively. Each pair of devices has a pair of epipoles. Device 1 and device 2 have epipoles E₁₂, E₂₁ on the planes 860, 870, respectively. Device 1 and device 3 have epipoles E₁₃, E₃₁, respectively on the planes 860, 880, respectively. Device 2 and device 3 have epipoles E₂₃, E₃₂ on the planes 870, 880, respectively. In other words, each reference plane includes two epipoles. The reference plane for device 1 includes epipoles E₁₂ and E₁₃. The reference plane for device 2 includes epipoles E₂₁ and E₂₃. The reference plane for device 3 includes epipoles E₃₁ and E₃₂.

Consider the situation of FIG. 8 in which device 3 is a projector, device 1 is a first camera, and device 2 is a second camera. Suppose that a projection point P₃, a first image point Pi, and a second image point P₂ are obtained in a measurement. These results can be checked for consistency in the following way.

To check the consistency of the image point Pi, intersect the plane P₃-E₃₁-E₁₃ with the reference plane 860 to obtain the epipolar line 864. Intersect the plane P₂-E₂₁-E₁₂ to obtain the epipolar line 862. If the image point Pi has been determined consistently, the observed image point P₁ will lie on the intersection of the calculated epipolar lines 862 and 864.

To check the consistency of the image point P₂, intersect the plane P₃-E₃₂-E₂₃ with the reference plane 870 to obtain the epipolar line 874. Intersect the plane P₁-E₁₂-E₂₁ to obtain the epipolar line 872. If the image point P₂ has been determined consistently, the observed image point P₂ will lie on the intersection of the calculated epipolar line 872 and epipolar line 874.

To check the consistency of the projection point P₃, intersect the plane P₂-E₂₃-E₃₂ with the reference plane 880 to obtain the epipolar line 884. Intersect the plane Pi-E₁₃-E₃₁ to obtain the epipolar line 882. If the projection point P₃ has been determined consistently, the projection point P₃ will lie on the intersection of the calculated epipolar lines 882 and 884.

The redundancy of information provided by using a 3D imager having three devices (such as two cameras and one projector) enables a correspondence among projected points to be established even without analyzing the details of the captured images and projected pattern features. Suppose, for example, that the three devices include two cameras and one projector. Then correspondence among projected and imaged points may be directly determined based on the mathematical constraints of the epipolar geometry. This may be seen in FIG. 8 by noting that a known position of an illuminated point on one of the reference planes 860, 870, 880 automatically provides the information needed to determine the location of that point on the other two reference planes. Furthermore, once correspondence among points has been determined on each of the three reference planes 860, 870, 880, a triangulation calculation may be performed using only two of the three devices of FIG. 8. A description of such a triangulation calculation is discussed in relation to FIG. 7.

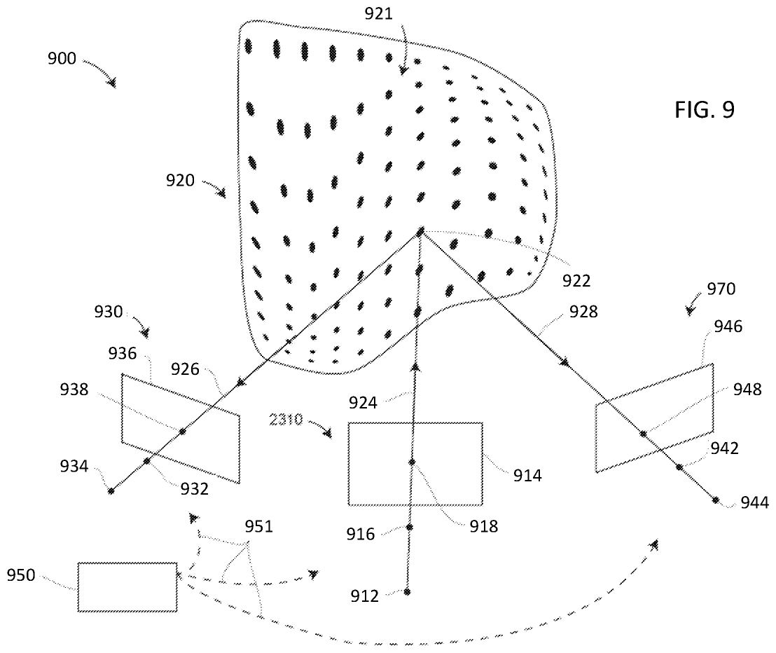

By establishing correspondence based on epipolar constraints, it is possible to determine 3D coordinates of an object surface by projecting uncoded spots of light. An example of projection of uncoded spots is illustrated in FIG. 9. In an embodiment, a projector 910 projects a collection of identical spots of light 921 on an object 920. In the example shown, the surface of the object 920 is curved in an irregular manner causing an irregular spacing of the projected spots on the surface. One of the projected points is the point 922, projected from a projector source element and passing through the perspective center 916 as a ray of light 924 forms a point 918 on the reference plane 914.

The point or spot of light 922 on the object 920 is projected as a ray of light 926 through the perspective center 932 of a first camera 930, resulting in a point 934 on the image sensor of the camera 930. The corresponding point 938 is located on the reference plane 936. Likewise, the point or spot of light 922 is projected as a ray of light 928 through the perspective center 942 of a second camera 940, resulting in a point 944 on the image sensor of the camera 940. The corresponding point 948 is located on the reference plane 946. In an embodiment, a processor 950 is in communication with the projector 910, first camera 930, and second camera 940. The processor determines correspondence among points on the projector 910, first camera 930, and second camera 940. In an embodiment, the processor 950 performs a triangulation calculation to determine the 3D coordinates of the point 922 on the object 920. An advantage of a scanner 900 having three device elements, either two cameras and one projector or one camera and two projectors, is that correspondence may be determined among projected points without matching projected feature characteristics. In other words, correspondence can be established among spots on the reference planes 936, 914, and 946 even without matching particular characteristics of the spots. The use of the three devices 910, 930, 940 also has the advantage of enabling identifying or correcting errors in compensation parameters by noting or determining inconsistencies in results obtained from triangulation calculations, for example, between two cameras, between the first camera and the projector, and between the second camera and the projector.

It should be noted that the scanner 10 of FIG. 1 can be used as any of the scanners (3D imagers) depicted in the other FIGS. herein.

A technical challenge when capturing scans with the scanner 10 is to implement simultaneous localization and mapping (SLAM). The scanner 10 incrementally builds the scan of the environment, while the scanner is moving through the environment, and simultaneously the scanner tries to localize itself on this scan that is being generated.

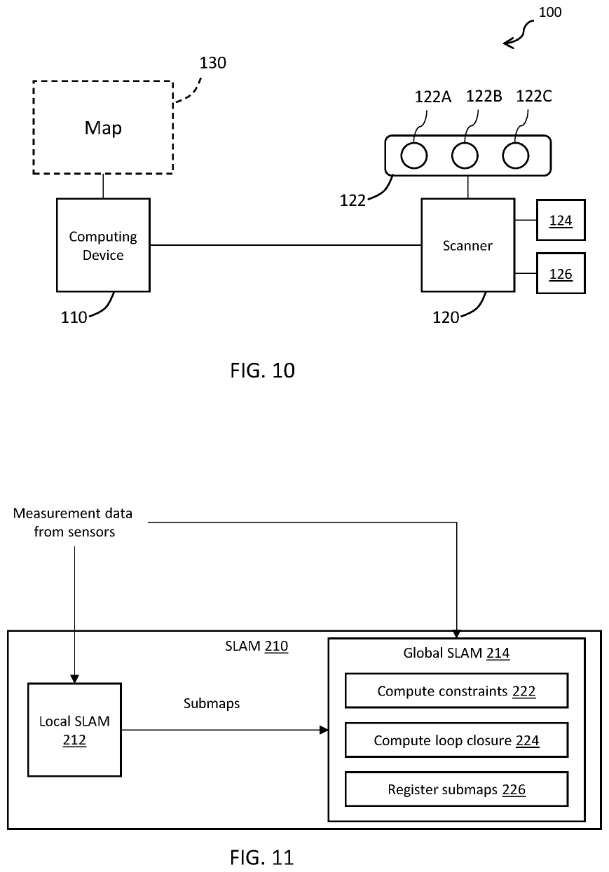

FIG. 10 depicts a system for scanning an environment according to one or more examples. The system 100 includes a computing system 110 coupled with a scanner 10. The coupling facilitates wired and/or wireless communication between the computing system 110 and the scanner 10. The scanner 10 captures measurements of the surroundings of the scanner 10, i.e., the environment. The measurements are transmitted to the computing system 110 to generate a map 130 of the environment in which the scanner is being moved. The map 130 can be generated by combining several submaps. Each submap is generated using SLAM.

FIG. 11 depicts a high level operational flow for implementing SLAM according to one or more examples. Implementing SLAM 210 includes generating one or more submaps corresponding to one or more portions of the environment. The submaps are generated using the one or more sets of measurements from the sets of sensors 122. Generating the submaps may be referred to as “local SLAM” (212). The submaps are further combined by the SLAM algorithm to generate the map 130. Combining the submaps process may be referred to as “global SLAM” (214). Together, generating the submaps and the final map of the environment is referred to herein as implementing SLAM, unless specifically indicated otherwise.

It should be noted that the operations shown in FIG. 11 are at a high level, and that typical implementations of SLAM 210 can include operations such as filtering, sampling, and others, which are not depicted.

The local SLAM 212 facilitates inserting a new set of measurement data captured by the scanner 10 into a submap construction. This operation is sometimes referred to as “scan matching.” A set of measurements can include one or more point clouds, distance of each point in the point cloud(s) from the scanner 10, color information at each point, radiance information at each point, and other such sensor data captured by a set of sensors 122 that is equipped on the scanner 10. For example, the sensors 122 can include a LIDAR 122A, a depth camera 122B, a camera 122C, etc. The scanner 10 can also include an inertial measurement unit (IMU) 126 to keep track of a 3D orientation of the scanner 10. In an example, the scanner 10 is a handheld portable laser line scanner that projects a laser line onto the surface of the object and the 3D coordinates are determined via epipolar geometry.

The captured measurement data is inserted into the submap using an estimated pose of the scanner 10. The pose can be extrapolated by using the sensor data from sensors such as IMU 126, (sensors besides the range finders) to predict where the scanned measurement data is to be inserted into the submap. Various techniques are available for scan matching. For example, a point to insert the measured data can be determined by interpolating the submap and sub-pixel aligning the scan. Alternatively, the measured data is matched against the submap to determine the point of insertion. A submap is considered as complete when the local SLAM 212 has received at least a predetermined amount of measurement data. Local SLAM 212 drifts over time, and global SLAM 214 is used to fix this drift.

It should be noted that a submap is a representation of a portion of the environment and that the map 130 of the environment includes several such submaps “stitched” together. Stitching the maps together includes determining one or more landmarks on each submap that is captured, aligning, and registering the submaps with each other to generate the map 130. Further, generating each submap includes combining or stitching one or more sets of measurements. Combining two sets of measurements requires matching, or registering one or more landmarks in the sets of measurements being combined.

Accordingly, generating each submap and further combining the submaps includes registering a set of measurements with another set of measurements during the local SLAM (212), and further, generating the map 130 includes registering a submap with another submap during the global SLAM (214). In both cases, the registration is done using one or more landmarks.

Here, a “landmark” is a feature that can be detected in the captured measurements and be used to register a point from the first set of measurements with a point from the second set of measurements.

The global SLAM (214) can be described as a pose graph optimization problem. As noted earlier, the SLAM algorithm is used to provide concurrent construction of a model of the environment (the scan), and an estimation of the state of the scanner 10 moving within the environment. In other words, SLAM provides a way to track the location of the scanner 10 in the world in real-time and identify the locations of landmarks such as buildings, trees, rocks, walls, doors, windows, paintings, décor, furniture, and other world features. In addition to localization, SLAM also generates or builds up a model of the environment to locate objects including the landmarks that surround the scanner 10 and so that the scan data can be used to ensure that the scanner 10 is on the right path as the scanner 10 moves through the world, i.e., environment. So, the technical challenge with the implementation of SLAM is that while building the scan, the scanner 10 itself might lose track of where it is by virtue of its motion uncertainty because there is no presence of an existing map of the environment because the map is being generated simultaneously.

The basis for SLAM is to gather information from the set of sensors 122 and motions over time and then use information about measurements and motion to reconstruct a map of the environment. The SLAM algorithm defines the probabilities of the scanner 10 being at a certain location in the environment, i.e., at certain coordinates, using a sequence of constraints. For example, consider that the scanner 10 moves in some environment, the SLAM algorithm is input the initial location of the scanner 10, say (0,0,0) initially, which is also called as initial constraints. The SLAM algorithm is then inputted several relative constraints that relate each pose of the scanner 10 to a previous pose of the scanner 10. Such constraints are also referred to as relative motion constraints.

The technical challenge of SLAM can also be described as follows. Consider that the scanner is moving in an unknown environment, along a trajectory described by the sequence of random variables x1:T={x1, . . . , xT}. While moving, the scanner acquires a sequence of odometry measurements u1:T={u1, . . . , uT} and perceptions of the environment z1:T={z1, . . . zT}. The “perceptions” include the captured data and the mapped detected planes 410. Solving the full SLAM problem now includes estimating the posterior probability of the trajectory of the scanner 10 x1:T and the map M of the environment given all the measurements plus an initial position x0: P (x1:T, M| z1:T, u1:T, x0). The initial position x0 defines the position in the map and can be chosen arbitrarily. There are several known approaches to implement SLAM, for example, graph SLAM, multi-level relaxation SLAM, sparse matrix-based SLAM, hierarchical SLAM, etc. The technical solutions described herein are applicable regardless of which technique is used to implement SLAM.

Thus, feature tracking is an essential part for any SLAM algorithm used for self-localization of devices as the scanner 10. Existing solutions address the technical challenge of feature tracking by using 2D features from the cameras 122. However, such techniques suffer from perspective distortions. Further, points that seem to be strong and feature rich may actually unsuitable to be used as tracking points because they are the intersection of edges in different depth. Such points do not represent a fixed real world 3D point.

Further, a technical challenge is to match the features that are tracked to features detected in other (or subsequent) scans to facilitate registration. Typically, descriptors are used to encode the features characteristics. The descriptors from one scan are compared to “track” or match the features across different scans.

The technical solutions described herein facilitate the scanner 10 to create a type of descriptor and underlying 3D patch that takes into account the geometry recorded by the scanner based on depth or normals of one or more planes in the environment. The features and corresponding descriptors generated in this manner can match more accurately and more reliably than existing image features. Accordingly, the technical solutions described herein provide improvements to the scanner 10 by facilitating a practical application to capture accurate scans using the scanner 10. The improvements are provided by addressing technical challenges rooted in computing technology, particularly in computer vision, and more particularly in capturing scans of an environment using a scanner.

The “features” that are tracked across different scans are points (or pixels) in images captured by the cameras 122 of the scanner 10. The camera 122 captures the images for texturing the 3D point cloud that is captured.

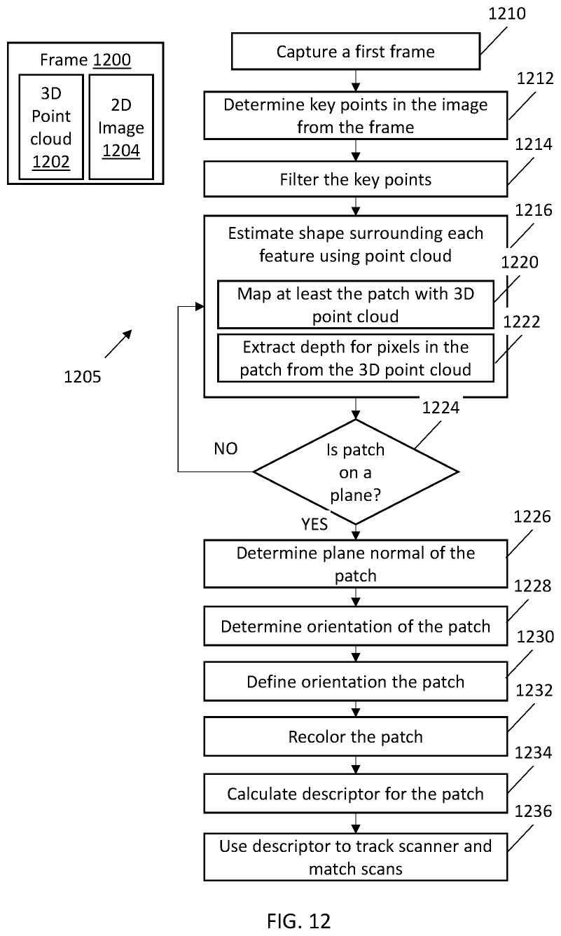

FIG. 12 depicts a flowchart of a method for using orthonormalized pre-aligned 3D patches for feature tracking for performing SLAM according to one or more embodiments. The method 1200 that is depicted can be performed by the system 100 in one or more embodiments. Alternatively, in one or more embodiments, the scanner 10 performs the method 1205.

The method 1200 includes, at block 1210, capturing a first frame 1200 that includes a 3D point cloud 1202 and a corresponding 2D image 1204 to be used as texture. Further, at block 1212, one or more key points are detected in the texture that can be used as features. The key points are detected automatically in one or more embodiments. For example, the key points are detected using an artificial intelligence (AI) model, such as using neural network(s). Alternatively, or in addition, image processing algorithms are used to detect the key points that can be used as features. The key points are determined using existing techniques that are known or that may be developed in the future. In some embodiments, the key points are determined semi-automatically, or manually. In some embodiments, the 3D point cloud 1202 may not be captured, and the 2D image 1204 may be corresponding to a collection of 3D points from other frames, wither previously captured, or that will be captured later. The points that are used are made consistent by transforming them to a predetermined coordinate system, such as the current frame's coordinate system.

Key point detection can be performed using one or more known algorithms such as, Harris corner detector, Harris-Laplace-scale-invariant version of Harris detector, multi-scale oriented patches (MOPs), scale invariant feature transform (SIFT), speeded up robust features (SURF), Features from accelerated segment test (FAST), binary robust invariant scalable key-points (BRISK) algorithm, oriented FAST and rotated BRIEF (ORB) algorithm, KAZE with M-SURF descriptor, and any other feature extraction technique.

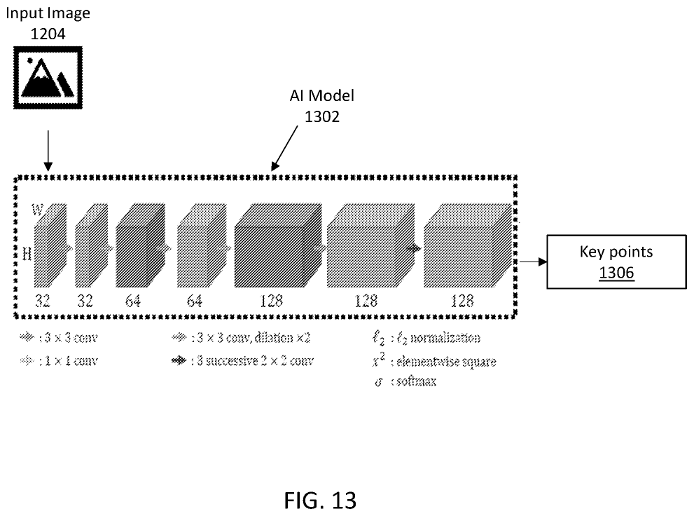

FIG. 13 depicts a block diagram for detection of key points according to one or more embodiments. The AI model 1302 receives the image 1204 as input. The AI model 1302 that is depicted is a fully connected L2 CNN, however, a different implementation can be used in other examples. The AI model 1302 that is depicted includes several layers that perform convolution operations with the input data and one or more filters of predetermined sizes. The values of the filters are predetermined during a training phase during which the values are adjusted by comparing the output of the AI model 1302 with ground truth. The AI model 1302 outputs key points 1306 based on the pixels in the input image 1204. In some embodiments, the key points 1306 are determined based on confidence maps representing repeatability and reliability for each pixel of the input image 1204, from which the locations of the key points 1306 are derived.

The AI model 1302, accordingly, operates as a feature “detector,” i.e., which is an algorithm which takes an input image 1204 and outputs key points “locations” (i.e., pixel coordinates) 1304 of significant areas in the input image 1202. An example is a corner detector, which outputs the locations of corners in the input image 1204.

Referring to the method 1200 in FIG. 12, at block 1214, the key points 1306 are filtered to identify points to be used as features.

At block 1216, depth of predetermined points around a feature are extracted and the shape surrounding the feature is estimated. The predetermined points can be referred to as a “3D patch.” The 3D patch is a surface patch that is part of the captured 3D points, and hence already in 3D (and not a 2D sub-image of the texture).

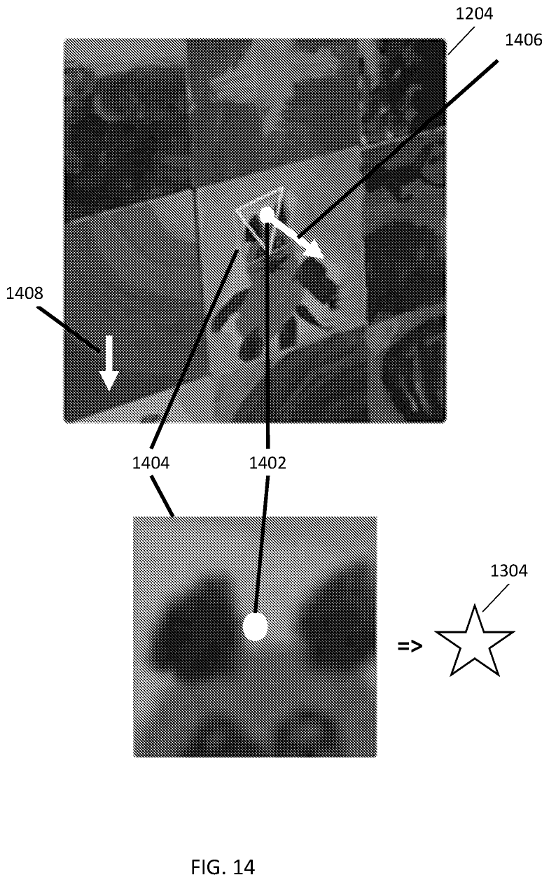

FIG. 14 depicts an example of a 3D patch according to one or more embodiments. A key point 1404 corresponding to a feature is depicted in an example 2D image 1204 captured by the scanner 10. A 3D patch 1404 is selected surrounding the key point 1402. A zoomed-in version of the 3D patch 1404 is also shown, with the key point 1402. In the depicted example, the 3D patch 1404 is a square of 31×31 pixels surrounding the key point. However, as noted herein, in other examples, the 3D patch 1404 can have a different size and/or a different shape. The 2D image 1204 can be a color image or a grayscale image.

Estimating the shape of the pixels in the 3D patch 1404 includes, at block 1220, mapping the 2D image 1204 with the 3D point cloud 1202 to determine correspondence between the location (2D coordinates in the image 1204) of the pixels in the 3D patch 1404, including the key point 1402, with points (3D coordinates in the point cloud 1202). The mapping can be performed using known techniques used for texture mapping. Example mapping techniques include projecting 3D points of the point cloud 1202 to a plane represented by the 2D image 1204.

The 3D patch 1404 itself is in 3D space, and not in image space of grey/color camera 122. The 3D patch 1404 is created around a feature point that is detected in the image 1204 taken from the camera 122. Hence, to create the 3D patch 1404, the 3D position of the feature point is first estimated, and then the 3D patch is created using the 3D points captured around the estimated 3D position of the feature point. In some embodiments, depth information for one or more points of the 3D patch is extracted from the 3d point cloud indirectly. The 3D point cloud 1202 may be sparser than the 3D patch. So, the surface model is estimated from the 3D points (i.e., the plane) and then the cells (i.e., points/pixels in the 3D patch) are created on that surface. In this manner, the depth of the 3D point of the 3D patch is known from creation of the 3D patch.

Estimating the 3D position can have two cases. In the first case, depth for the feature point in the image 1204 is unknown. In this case the feature is enhanced with depth by projecting the 3D points into the image 1204 and checking which points match the feature neighborhood. In the second case, the 3D depth of the feature point might already be known from previous tracking. Tracked features get depth information when used in SLAM.

Further, depth information for each pixel in the 3D patch 1404 can be extracted from the respective corresponding point from the 3D point cloud 1202, at block 1222. Based on the depth information, a shape around the key point 1402 in the 3D patch 1404 can be estimated. The 3D patch 1404 can be a 31×31 pixel area surrounding the feature in one or more embodiments. Other 3D patches can be used in other embodiments, for example, a circular patch, or a patch with different dimensions, or any other variation is possible etc. In some embodiments, the pixel size of the 3D patch 1404 is determined based on a real-world size. For example, to cover an area of about 15.5 millimeter×15.5 millimeter around the feature in the environment, the 31×31 pixel 3D patch is used with a spacing of 0.5 millimeter. The pixel size of the 3D patch 1404 can be adjusted based on a distance between the scanner and the object being scanned. In one or more embodiments, the operator of the scanner can change the size via the user interface. For a different real-world area coverage, a different pixel size of the 3D patch is selected. In this manner, the 3D patch has well defined real world size in object space (compared to typical 2D patches, which are defined in image space). FIG. 16 shows three different combinations of spacing and sizes of a 3D patch 1404, and in all three cases the 3D patch 1404 corresponding to the same real world size.

In one or more embodiments, estimating the shape can include determining a plane surrounding the key point 1402. A plane-fitting algorithm (known, or later developed) can be used for determining a plane surrounding the key point 1402. Based on the plane fitting, it is determined whether the 3D patch 1404 is on a plane in the environment (e.g., wall, painting, book, furniture, window, door, etc.), at 1224.

Accordingly, by knowing the 3D position of the feature point in the 2D image 1204, 3D neighbors of that 3D position are extracted, and their planarity is checked to create the raster for the 3D patch 1404 on that plane. In this manner, in embodiments described herein, the depth points (i.e., 3D points) are used to get the position and orientation of the local plane around the feature point.

At block 1226, a plane normal 1406 is determined for the plane of the 3D patch 1404 upon determination that the 3D patch coincides with a plane in the environment. The plane normal 1406 represents one part of an orientation of the 3D patch 1404. To fully create the 3d patch image two orthogonal vectors U and V are calculated, where both U and V are in the plane of the 3D patch 1404. The 3d patch coordinate system is defined by the 3 orthogonal vectors N (1406), U and V. If the 3D patch 1404 is not horizontal, (i.e., the plane normal and gravity vector are not colinear) V is defined to be the projection of gravity 1408 onto the plane. This vector V is always orthogonal to the plane normal and now U is calculated from (1406) and V being orthogonal to both. This way, gravity can be used to define the rotation around that normal vector if the gravity vector sufficiently differs from the plane normal (i.e., the projection of the gravity vector onto the surface patch has a certain length). This projection of the gravity vector then marks the remaining part of the orientation of the 3D patch 1404.

The orientation (rotation around the plane normal 1406) of the 3D patch 1404 is determined using the sensors 122 of the scanner 10, at block 1228. For planes that are not horizontal the projection of the measured gravity vector 1408 is used to determine the orientation. The projection of the measured gravity vector 1408 can be determined from the IMU 126.

The orientation of the 3D patch is defined so that the horizontal axis U, the plane normal 1406, and the projection of the gravity vector 1408 on the plane, are all orthogonal to each other, at 1230. The vector V equals the gravity vector 1408 for vertical planes like a wall and becomes zero and thus instable for horizontal planes like tables or floors. Being the projection of the gravity vector, V is defined to as similar to the gravity vector 1408 as possible while lying on the plane, and U is orthogonal to V, and further, both orthogonal to the plane normal. In this manner, V is defined by the projection of the gravity vector 1408 onto the plane. In case of a wall, V equals gravity. In case of a horizontal plane the plane normal is equal to gravity, the projection of gravity onto the plane becomes zero length and the patch orientation cannot be defined using measured gravity. For horizontal planes different methods are used to get the rotation of the 3D patch 1404 around the normal. Assuming the scanner pose is sufficiently known from tracking or any other pre-alignment, a different direction e.g., the global Y axis, is used instead of gravity (global Z axis) and, thus, V is defined as the projection of Y. Alternatively, a second method can include using an arbitrary rotation first, colorizing the 3D patch 1404 and then defining V as the direction from the 3D patch center to a characteristic point within the 3D patch 1404 (e.g., grayscale center of gravity). U can be determined from V and normal and the re-oriented 3D patch 1404 is subsequently calculated.

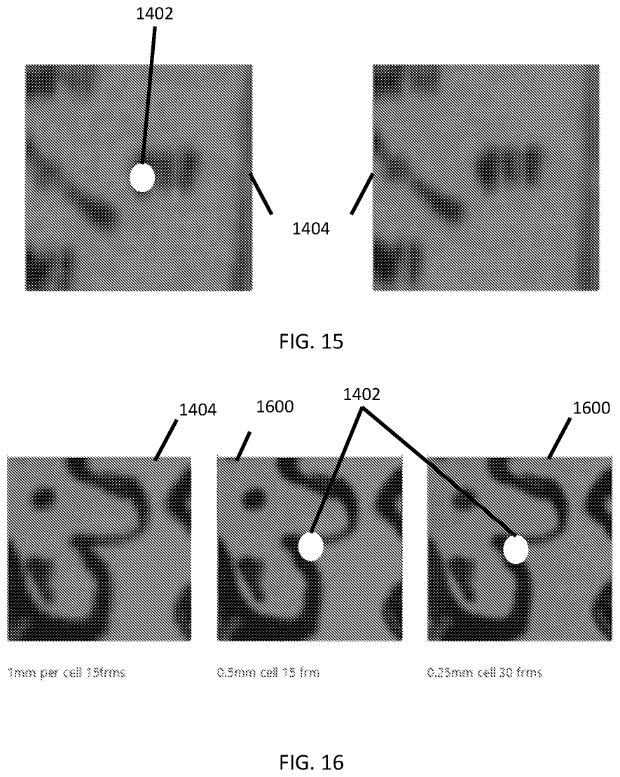

The 3D patch 1404 is recolored, at block 1232. This pixels in the reoriented 3D patch 1404 are colorized (gray or color) from one or more temporally neighboring images 1202, which are from other frames 1200 that are captured within a predetermined duration (before and/or after) the frame 1200 being analyzed. More the number of temporal neighboring images used, more the noise reduction. FIG. 15 depicts an example of recolored 3D patch 1404.

Recoloring the 3D patch 1404 includes selecting a set of temporal neighboring images of the image 1204. The temporal neighboring images are images that are captured within a predetermined time (e.g., 30 seconds) before and/or after the image 1204. Alternatively, a predetermined number of predecessor and successor images are used, for example, 5 predecessors and successors. The colors of pixels from the temporal neighboring images at the same location as a 3D point in the 3D patch 1404 are combined to determine the color of the 3D point in the 3D patch 1404. The combination of the colors of the pixels from the temporal neighboring images can be averaging, weighted averaging, interpolating, median, or any other type of combination. It should be noted that “color” can be a grayscale value in some embodiments. The combination of the temporal neighboring images also reduces noise, for example, artifacts introduced by compression (e.g., JPEG). Thus, each raster cell in the 3D patch 1404 has a 3D position, which is colorized by projecting the 3D position into one or more color images 1204 (temporal neighbors). By projecting the 3D coordinates of a point in the 3D patch into the dense color image(s) a color value for that 3D point can be obtained because the color image 1204 is denser compared to the captured 3D point clouds 1202.

In some embodiments, rasterizing the temporal neighboring images at a higher resolution than the size of each single image 1204 gives a super-resolution 3D patch. FIG. 16 depicts an example of a super-resolution 3D patch 1600. The super-resolution 3D patch 1600 has a higher rasterization resolution compared to the 3D patch 1404.

A descriptor is calculated for the 3D patch 1404, at block 1234. In some embodiments, once all corresponding 3D patches 1404 are defined in scale and rotation for all the filtered key points 1306, a descriptor for each of the 3D patches 1404 is calculated. Various existing (or later developed) algorithms can be used to calculate the descriptor (feature vectors). Typically, an algorithm takes the 3D patch 1404 as input and outputs a corresponding feature descriptor, which encodes the detected information into a series of numbers that act as a “fingerprint” or “signature” that can be used to differentiate one descriptor (i.e., 3D patch 1404) from another. For example, the following descriptor definitions can be used: normalized gradient, principal component analysis (PCA) transformed image patch, histogram of oriented gradients, gradient location and orientation histogram (GLOH), local energy-based shape histogram (LESH), BRISK, ORB, fast retina key-point (FREAK), and local discriminant bases (LDB).

The descriptors 1304 are invariant under image transformation (1204) because they are not calculated in this image space but in the 3D patch image space, so the feature corresponding to the 3D patch 1404 can be found again even if the sensor image 1204 is transformed in some way, e.g., rotated, zoomed, etc. The invariance is an effect of the 3D patch 1404 being created using 3D positions (from the 3D point cloud). Further, using operations described herein, the 3D patches 1404 are well defined and include a well-defined scale (real world size patch) and the rotation (e.g., by gravity).

In some embodiments, after successful matching two 3D patches 1404, further refinement can be performed to obtain subpixel accuracy to align the two 3D patches 1404. For example, a pattern matching can be performed on the two 3D patches 1404 and the alignment of the one (or both) of the matching 3D patches 1404 is adjusted to improve the matching between the respective patterns. This is possible because the 3D patches 1404 are normalized, i.e., are scaled and oriented according to real world scale and orientation, and they use the surface based on a surface normal direction instead of scanner direction, which can vary. Such refinement can further improve the accuracy of the matching, and consequently the accuracy of SLAM, loop closure, or any other application that uses the two matching 3D patches 1404.

The 3D patches 1404, based on the descriptors, can be used for tracking the position of the scanner 10, at block 1236. The tracking can be performed using existing techniques where the descriptors of two or more 3D patches 1404 are compared to determine whether they match. If the comparison results in at least a predetermined level of matching, the frames 1200 from which the 3D patches 1404 match, are registered with each other. Further, a 3D point cloud that is captured in the frame is aligned with the overall 3D point cloud, i.e., map, of the environment being scanned.

In one or more embodiments, a quality indicator is computed for each 3D patch 1404. The quality indicator can, for example, be the noise of the underlying plane, the brightness of the 3D patch 1404 in the 2D image 1204, the corresponding image quality, the viewing angle of the plane, the distance between the 3D patch (e.g., center) and the scanner 20, among other parameters and a combination thereof. Based on the quality indicator of the matched 3D patches 1404, a weight of a 3D patch combination used for the overall alignment of the point clouds can be determined. In some embodiments, 3D patches 1404 with quality indicators below a certain threshold may be discarded, and not used for alignment. Alternatively, or in addition, pairs of 3D patches 1404 with difference in the respective quality indicators being above a predetermined threshold, may not be used to match with each other, and consequently the frames are not used for the registration and/or alignment.

Implementing global SLAM 214 includes determining constraints (222) between nodes captured by the scanner 10, i.e., submaps, objects, landmarks, or any other elements that are matched. Non-global constraints (also known as intra submaps constraints) are built automatically between nodes that are closely following each other on a trajectory of the scanner 10 in the environment. Global constraints (also referred to as loop closure constraints or inter submaps constraints) are constraints between a new submap and previous nodes that are considered “close enough” in space and a strong fit, i.e., a good match when running scan matching. Here, “close enough” is based on predetermined thresholds, for example, distance between the same landmark from two submaps being within a predetermined threshold.

For example, existing implementations of SLAM use measurements, such as LIDAR data, from the set of sensors of the scanner 10, to aggregate the measurements to generate the submaps and eventually the map 130. A technical challenge with such implementations is that the matching of the sets of measurements is inaccurate due to ambiguities or missing data. This may lead to misaligned sets of measurements and/or submaps, which in turn, cause an erroneous submap and/or map 130. In some embodiments, “loop closure” 224 is used to prevent such errors by compensating for accumulated errors. However, because of missing data or ambiguities in the data that is collected, the result of the SLAM implementation can be adversely affected by missing loop closure and/or by drift. A “missing loop closure” indicates that during execution of the global SLAM 2214, a loop closure 224 is not deemed necessary based on the constraints and/or the measurement data that is received. Alternatively, the drift from the measurement data is larger than a predetermined threshold, and hence, is not compensated by the loop closure 224. Accordingly, registering the submaps 226 can result in misaligned submaps.

To address the technical challenges with the misaligned submaps, embodiments described herein use the 3D patches 1404 as described herein for correcting position errors during runtime, when a drift of position or missing loop closure occurs and is detected.

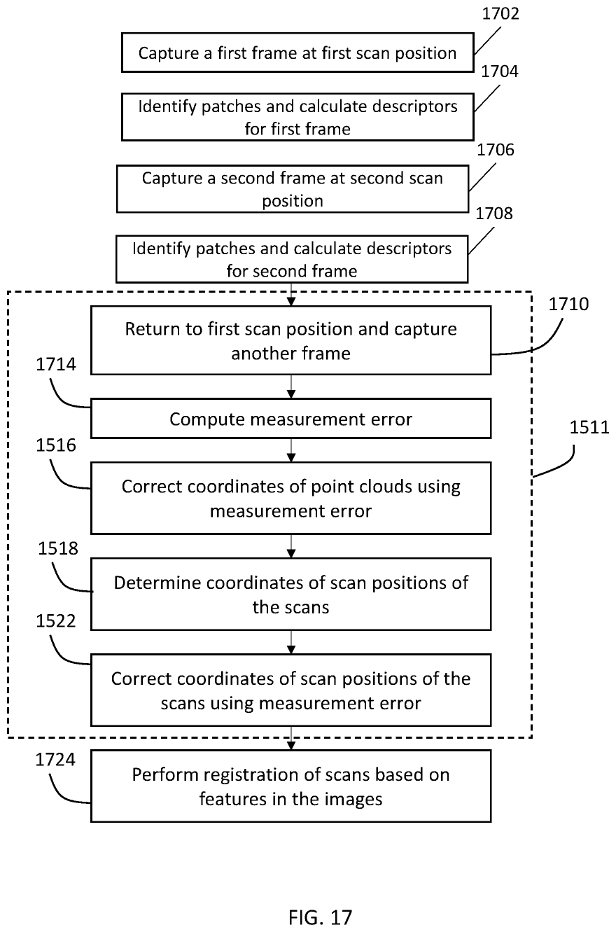

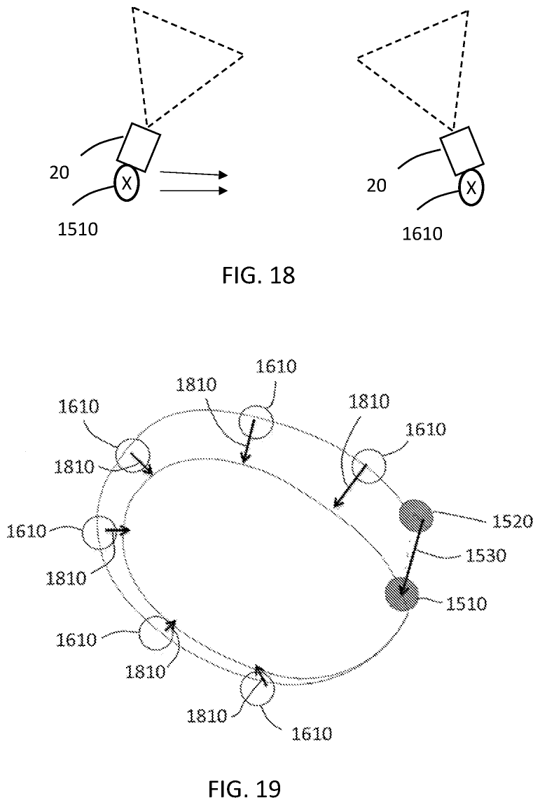

FIG. 17 depicts a flowchart for using orthonormal 3D patches for performing loop closure according to one or more embodiments. The method 1700 of FIG. 17 is described in conjunction with the example scenario depicted in FIG. 18. At block 1702, the scanner 20 is used to perform a scan at a first position 1510 (FIG. 18). During the scan at the first position 1510, the scanner 20 acquires a first frame 1200, which includes the texture image 1204, and the point cloud 1202 with 3D coordinates for a first plurality of points on surfaces in the environment being scanned. In an embodiment, timestamp, and a pose of the scanner 10 are also captured. The pose includes one or more sensor measurements (e.g., IMU measurements).

A first set of one or more 3D patches 1404 is identified as features from the first frame 1200, at block 1704. The 3D patches 1404 are identified and descriptors for the 3D patches 1404 are computed as described herein (method 1200).

Further, a second frame 1200 is captured at a second scan position 1610, at block 1706. An estimated pose of the scanner 20 is also captured in association with the scan. It should be appreciated that in some embodiments, the method 1700 may then loop back to block 1706 and additional scanning is performed at additional locations.

A second set of one or more 3D patches 1404 is identified as features from the second frame 1200, at block 1708. The 3D patches 1404 are identified and descriptors for the 3D patches 1404 are computed as described herein (method 1200).

In some embodiments, the sets of 3D patches 1404 are determined after all the frames have been captured. It should be understood that the sequence of operations can be varied in some embodiments from the sequence depicted in FIG. 17.

The scanner 20 continues to capture scans at multiple scan positions 1610 and returns to the first scan position, at block 1710. Capturing the present position procedure is repeated for every scan. For example, if the scanner 20 captures n scans a data structure holds n positions with n links to the corresponding frame 1200 of the portion scanned at that position. In one or more examples, the scanner 20 saves the present position in a data structure such as a list of positions. Every position in the data structure is linked directly to the data structure that is used to store the frame 1200 of the corresponding portion of the environment.

At the position 1510 where landmark that was added before, the measurement error 1530 is computed that is input into the SLAM algorithms to correct the error/drift accumulated from walking around the scanned portion of the environment, at block 1714. In one or more embodiments of the present disclosure, computing the measurement error 1530 (FIG. 19) includes moving the scanner 20 to an estimated position 1520. The estimated position is an estimate of the first scan position 1510 corresponding to the first set of 3D patches 1404. The difference 1530 between the recorded first position 1510 and the present position 1520 is used as the error correction to update and correct the mapping positions.

In one or more examples, the difference is computed as a difference in the original image 1204 and the present image 1204 when the scanner 20 is at the estimated first scan position. For example, the difference between the images is computed based on the 3D patches 1404 in the first image 1204 and the present view.

The method 1700 further includes using the measurement error 1530 to correct the coordinates captured by the scanner 20, at block 1716. The portion of the map 130 that are scanned and stored since capturing the first set of 3D patches are updated using the measurement error 1530, in one or more examples. In one or more examples, a loop closure operation is executed on the map 130, and parts of the map are corrected in order to match the real pose, which is the starting position 1510, with the estimated pose, which is the different position 1520. The loop closure algorithm calculates a displacement for each part of the map 130 that is shifted by the algorithm.

In one or more examples, the scanner 20 determines the scan positions 1610 (FIG. 19) linked to each portion of the map 130, at block 1718. In one or more examples, a lookup is performed over the data structure that saves the list of positions. The lookup costs a single processor operation, such as an array lookup. The scanner 20 applies the displacement vector for a portion of the map to the corresponding scan positions saved in the data structure and saves the resulting displaced (or revised) scan positions back into the data structure, at block 1722. The displaced scan positions are computed for each of the saved scan positions 1610 in the data structure. The procedure 1711 can be repeated every time the loop closure algorithm is applied.

The displaced scan positions represent corrected scan positions of the scans that can be used directly without applying further computational expensive point cloud registration algorithms. The accuracy of the scan positions 1610 depends on the sensor accuracy of the scanner 20. As shown in FIG. 19, the displacement vectors 1810 for the portions of the map are determined based on the loop closure operation. The displacement vectors 1810 are applied to the scan positions 1610 linked to the portions of the map by the data structure as described herein. The resulting displaced scan positions 1910 are accordingly calculated by applying the displacement vectors 1810 to the scan positions 1610. The displaced scan positions 1910 are now correctly located.

Referring back to FIG. 17, in an embodiment the method 1700 further includes registering the scans using the features that are detected using images 1204 at each scan position, at block 1724. The registration can further be used as constraints for the SLAM implementation. The registration can be performed at runtime in one or more embodiments. Determining the constraint, i.e., registration, includes generating a relationship by matching the features that are detected from a first scan position 1610 with corresponding (same) features that are detected in an earlier frame from a different scan position.

The 3D patches 1404 can also be used in the global SLAM 214 optimization as constraints for the connection between the submaps and the orientation of the scanner 10. Once the loop closure 224 is completed, the global SLAM 214 is completed by registering 226 the submaps and stitching the submaps to generate the map 130 of the environment. In one or more embodiments, SLAM 210 is performed iteratively as newer measurements are acquired by the scanner 10.

In one or more embodiments, the scanner 10 is coupled with a computing system such as, a desktop computer, a laptop computer, a tablet computer, a phone, or any other type of computing device that can communicate with the scanner 10. One or more operations for implementing SLAM can be performed by the computing system. Alternatively, or in addition, one or more of the operations can be performed by a processor 122 that is equipped on the scanner 10. In one or more embodiments, the processor 122 and the computing system can implement SLAM in a distributed manner. The processor 122 can include one or more processing units. The processor 122 controls the measurements performed using the set of sensors. In one or more examples, the measurements are performed based on one or more instructions received from the computing system.

In one or more embodiments, the computing device and/or a display (not shown) of the scanner 10 provides a live view of the map of the environment being scanned by the scanner 10 using the set of sensors. The map can be a 2D or 3D representation of the environment seen through the different sensors. The map can be represented internally as a grid map. A grid map is a 2D or 3D arranged collection of cells, representing an area of the environment. In one or more embodiments, the grid map stores for every cell, a probability indicating if the cell area is occupied or not. Other representations of the map can be used in one or more embodiments.

As noted earlier, the scanner 10, along with capturing the map, is also locating itself within the environment. The scanner 10 uses odometry, which includes using data from motion or visual sensors to estimate the change in position of the scanner 10 over time. Odometry is used to estimate the position of the scanner 10 relative to a starting location. This method is sensitive to errors due to the integration of velocity measurements over time to give position estimates.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions, or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. An apparatus comprising:
a scanner that captures a 3D map of an environment, the 3D map comprising a plurality of 3D point clouds;
a camera that captures a 2D image corresponding to each 3D point cloud from the plurality of 3D point clouds; and
one or more processors coupled with the scanner and the camera, the one or more processors configured to perform a method comprising:
capturing a frame comprising a 3D point cloud and the 2D image;
detecting a key point in the 2D image, the key point can be used as a feature;
creating a 3D patch, wherein the 3D patch comprises points surrounding a 3D position of the key point, the 3D position and the points of the 3D patch are determined from the 3D point cloud;
based on a determination that the points in the 3D patch are on a single plane based on the corresponding 3D coordinates, computing a descriptor for the 3D patch;
registering the frame with a second frame by matching the descriptor for the 3D patch with a second descriptor associated with a second 3D patch from the second frame; and
aligning the 3D point cloud with the plurality of 3D point clouds based on the registered frame.

2. The apparatus of claim 1, wherein the 3D patch is of a predetermined dimension.

3. The apparatus of claim 1, wherein the 3D patch is of a predetermined shape.

4. The apparatus of claim 1, wherein the 2D image is one of a color image and a grayscale image.

5. The apparatus of claim 1, wherein the method further comprises computing a loop closure, wherein computing the loop closure comprises:
capturing the second frame from substantially the same position as the frame;
computing a difference in the pose of the scanner based on a difference in orientation of matching 3D patches in the frame and the second frame; and
updating the map by adjusting coordinates based on the difference.

6. The apparatus of claim 5, wherein an orientation of a 3D patch is compared to a direction of gravity to determine difference in orientation of matching 3D patches.

7. The apparatus of claim 1, wherein the 3D patch is recolored using images within a predetermined temporal neighborhood.

8. The apparatus of claim 7, wherein colors of points in the 3D patch are used to generate the descriptor for the 3D patch.

9. The apparatus of claim 1, wherein an orientation of the 3D patch is defined based on a plane normal computed for the single plane of the 3D patch.

10. The apparatus of claim 1, wherein the key point is detected using an artificial intelligence model.

11. The apparatus of claim 1, wherein the method further comprises:
computing a first quality metric of the 3D patch, and a second quality metric of the second 3D patch;
matching the descriptors for the first 3D patch and the second 3D patch in response to a difference between the first quality metric and the second quality metric being within a predetermined threshold. 12.

12. A method comprising:
capturing a frame comprising a 3D point cloud and a 2D image to generate a map of an environment, the map generated using a plurality of 3D point clouds;
detecting a key point in the 2D image, the key point is a candidate to be used as a feature;
creating a 3D patch of a predetermined dimension, wherein the 3D patch comprises points surrounding a 3D position of the key point, the 3D position and the points of the 3D patch are determined from the 3D point cloud;
based on a determination that the points in the 3D patch are on a single plane based on the corresponding 3D coordinates, computing a descriptor for the 3D patch;
registering the frame with a second frame by matching the descriptor for the 3D patch with a second descriptor associated with a second 3D patch from the second frame; and
aligning the 3D point cloud with the plurality of 3D point clouds based on the registered frame.

13. The method of claim 12, wherein the 2D image is one of a color image and a grayscale image.

14. The method of claim 12, wherein the method further comprises computing a loop closure, wherein computing the loop closure comprises:
capturing the second frame from substantially the same position as the frame;
computing a difference in the pose of the scanner based on a difference in orientation of matching 3D patches in the frame and the second frame; and
updating the map by adjusting coordinates based on the difference.

15. The method of claim 12, wherein the 3D patch is recolored using images within a predetermined temporal neighborhood.

16. The method of claim 12, wherein the method further comprising:
computing a first quality metric of the 3D patch, and a second quality metric of the second 3D patch; and
matching the descriptors for the first 3D patch and the second 3D patch in response to a difference between the first quality metric and the second quality metric being within a predetermined threshold.

17. A system comprising:
a scanner comprising:
a 3D scanner; and
a camera; and
a computing system coupled with the scanner, the computing system configured to perform a method comprising:
capturing a frame comprising a 3D point cloud and a 2D image to generate a map of an environment, the map generated using a plurality of 3D point clouds;
detecting a key point in the 2D image, the key point is a candidate to be used as a feature;
creating a 3D patch of a predetermined dimension, wherein the 3D patch comprises points surrounding a 3D position of the key point, the 3D position and the points of the 3D patch are determined from the 3D point cloud;
based on a determination that the points in the 3D patch are on a single plane based on the corresponding 3D coordinates, computing a descriptor for the 3D patch;
registering the frame with a second frame by matching the descriptor for the 3D patch with a second descriptor associated with a second 3D patch from the second frame; and
aligning the 3D point cloud with the plurality of 3D point clouds based on the registered frame.

18. The system of claim 17, wherein the method further comprises computing a loop closure, wherein computing the loop closure comprises:
capturing the second frame from substantially the same position as the frame;
computing a difference in the pose of the scanner based on a difference in orientation of matching 3D patches in the frame and the second frame; and
updating the map by adjusting coordinates based on the difference.

19. The system of claim 17, wherein the 3D patch is recolored using temporally neighboring images.

20. The system of claim 17, the 3D patch is recolored using images within a predetermined temporal neighborhood.

21. The system of claim 17, wherein the method further comprising:
computing a first quality metric of the 3D patch, and a second quality metric of the second 3D patch; and
matching the descriptors for the first 3D patch and the second 3D patch in response to a difference between the first quality metric and the second quality metric being within a predetermined threshold.

22. The system of claim 17, wherein an orientation of a 3D patch is compared to a direction of gravity to determine difference in orientation of matching 3D patches.
